(19) United States
(12) Patent Application Publication
(10) Pub. No.: US 2026/0291612 A1
(43) Pub. Date: Sep. 24, 2026

(54) MULTICORE FIBER OPTICAL TRANSCEIVER

(71) Applicant: TeraHop USA Inc., San Jose, CA (US)

(72) Inventors: Rang-Chen YU, San Jose, CA (US); Wangsheng ZHANG, Fremont, CA (US)

(21) Appl. No.: 19/569,005

(22) Filed: Mar. 17, 2026

Related U.S. Application Data
(60) Provisional application No. 63/773,524, filed on Mar. 18, 2025.

(51) Int. Cl. H04B 10/40; H04B 10/25; H04B 10/50; H04B 10/69; H04J 14/02

(52) U.S. Cl. CPC H04B 10/40; H04B 10/2589; H04B 10/5053; H04B 10/69; H04J 14/0307

(57) ABSTRACT

A multicore fiber (MCF) transceiver includes at least one multicore fiber (MCF) including a plurality of optical cores. The MCF transceiver includes at least one multicore fiber (MCF) converter configured to interface with the plurality of optical cores of the MCF. The MCF transceiver includes a transmitter and receiver array coupled to the MCF converter and configured to process signals received from or transmitted to the MCF via the MCF converter. At least part of the transmitter and receiver array is formed in a photonic integrated circuit (PIC).

### CROSS-REFERENCE TO RELATED APPLICATIONS

This application claims priority to U.S. Provisional Application No. 63/773,524, titled MULTICORE FIBER OPTICAL TRANSCEIVER, filed Mar. 18, 2025, which is hereby incorporated by reference in its entirety.

### FIELD OF INVENTION

The present disclosure relates to optical communication systems, and more particularly to a multicore fiber optical transceiver integrating multicore fiber converters with photonic integrated circuits for high-density optical signal transmission and reception.

### BACKGROUND

Artificial Intelligence (AI) data centers are increasingly deploying large numbers of high-density fiber-optic connections. For example, scaling an AI Graphics Processing Unit (GPU) pod may require on the order of 5,000 fiber-optic cables. Managing such a substantial fiber infrastructure is becoming a significant bottleneck in data-center deployment and operation. Although traditional Wavelength Division Multiplexing (WDM) optics can reduce the number of required fibers, they introduce increased optical loss and higher cost. In addition, WDM optics require precise wavelength control to mitigate fiber dispersion at higher baud rates. Accordingly, there is a need for optical communication solutions that alleviate the challenges associated with managing large numbers of optical fibers in high-density data center environments.

### SUMMARY

The present disclosure addresses the challenges associated with managing large numbers of optical fibers in high-density data center environments by integrating multicore fiber with photonic integrated circuits, which may reduce the number of optical input/output fibers required while avoiding the optical loss, cost, and wavelength control challenges associated with traditional optics.

According to an aspect of the present disclosure, a multicore fiber (MCF) transceiver is provided. The MCF transceiver includes at least one multicore fiber (MCF) including a plurality of optical cores. The MCF transceiver includes at least one multicore fiber (MCF) converter configured to interface with the plurality of optical cores of the MCF. The MCF transceiver includes a transmitter and receiver array coupled to the MCF converter and configured to process signals received from or transmitted to the MCF via the MCF converter. At least part of the transmitter and receiver array is formed in a photonic integrated circuit (PIC).

According to other aspects of the present disclosure, the MCF transceiver may include one or more of the following features. The MCF may include a transmitting MCF and a receiving MCF. The transmitter and receiver array may include a laser source configured to provide optical signals to the transmitting MCF. The transmitter and receiver array may include a modulator array configured to modulate the optical signals. The transmitter and receiver array may include drivers configured to provide driving signals to the modulator array. The transmitter and receiver array may include a photodetector array configured to convert optical signals received from the receiving MCF to electrical signals. The transmitter and receiver array may include a transimpedance amplifier configured to amplify the electrical signals from the photodetector array.

According to other aspects of the present disclosure, the MCF transceiver may further include a MCF fiber attachment unit configured to provide a mechanical and optical interface for attaching the at least one multicore fiber to the at least one MCF converter.

According to other aspects of the present disclosure, the transmitter and receiver array may include a transmitter array and a receiver array. The transmitter array may be a parallel single-mode (PSM) transmitter array formed in the PIC, and components of the receiver array may be separate from the PIC. Alternatively, the transmitter array may be a wavelength division multiplexing (WDM) transmitter array formed in the PIC, and components of the receiver array may be separate from the PIC. The transmitter array and the receiver array may be formed in the same PIC.

According to other aspects of the present disclosure, the PIC may be formed with a waveguide, and a pitch of the waveguide of the PIC may be aligned to a pitch of the MCF.

According to other aspects of the present disclosure, the MCF converter may be a free space coupling type in which light from single-mode fibers is deformed into parallel light using collimating lenses at an edge of the MCF. The MCF converter may be a fused tapered type in which each single-mode fiber is inserted into a multi-porous glass capillary, and the glass is annealed, drawn, and cut to form a fan-in/fan-out device with a cross-sectional structure similar to the MCF. The MCF converter may be a 3D waveguide type in which a waveguide is formed in a high and low refractive index area. The 3D waveguide may include a plurality of optical cores embedded within the 3D waveguide. The 3D waveguide may include a protective mesh surrounding the plurality of optical cores. The plurality of optical cores may be arranged in a circular pattern at a first end of the 3D waveguide and in a linear pattern at a second end of the 3D waveguide.

According to other aspects of the present disclosure, the MCF transceiver may be configured in a form factor selected from a group comprising Quad Small Form-factor Pluggable (QSFP), Quad Small Form-factor Pluggable Double Density (QSFP-DD), Octal Small Form-factor Pluggable (OSFP), Octal Small Form-factor Pluggable Extended Distance (OSFP-XD), near-packaged optics (NPO), external-packaged optics (XPO), and co-packaged optics (CPO).

According to other aspects of the present disclosure, the PIC may be a silicon photonics (SiPhotonics) PIC. The PIC may be a thin-film lithium niobate (TFLN)-on-silicon PIC. The PIC may include indium gallium arsenide (InGaAs) photodetectors (PDs). The PIC may include germanium-on-silicon (Ge/Si) photodetectors (PDs). The PIC may include silicon photonics modulators and germanium-on-silicon (Ge/Si) photodetectors (PDs) integrated on the same PIC.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a schematic block diagram of a multicore fiber optical transceiver, according to an embodiment of the present disclosure.

FIG. 2A is a perspective view of a multicore fiber optical transceiver, according to an embodiment of the present disclosure.

FIG. 2B is an exploded perspective view of the multicore fiber optical transceiver of FIG. 2A, according to an embodiment of the present disclosure.

FIG. 3A is a perspective view of a 3D waveguide, according to an embodiment of the present disclosure.

FIG. 3B is a side view of the 3D waveguide of FIG. 3A from a first end, according to an embodiment of the present disclosure.

FIG. 3C is a side view of the 3D waveguide of FIG. 3A from a second end, according to an embodiment of the present disclosure.

FIG. 4A is a perspective view of a photonic integrated chip, according to an embodiment of the present disclosure.

FIG. 4B is a cross-sectional view of the photonic integrated chip of FIG. 4A, according to an embodiment of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

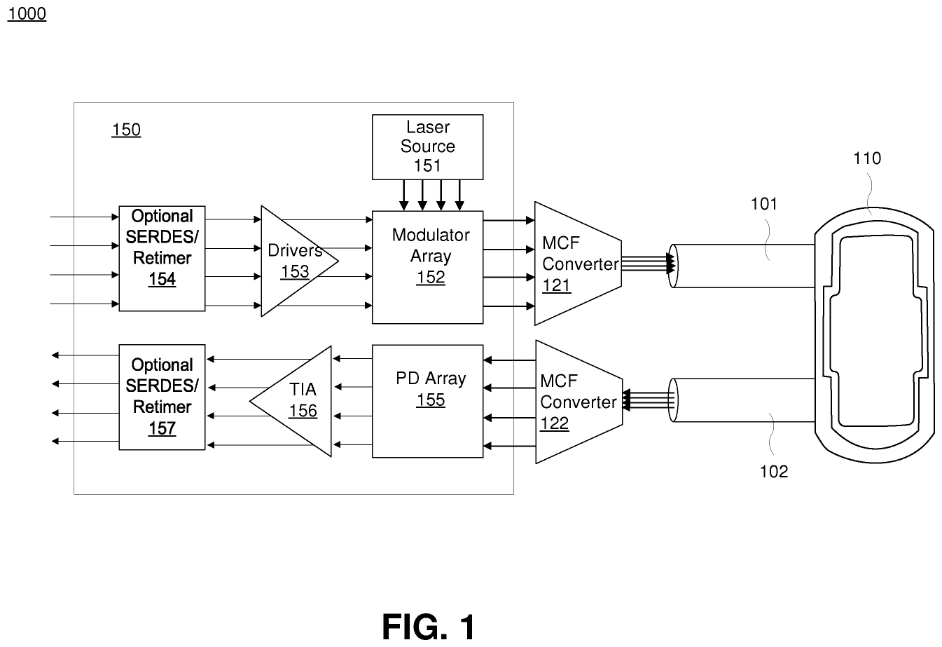

FIG. 1 illustrates a schematic block diagram of a multicore fiber optical transceiver 1000 according to an embodiment of the present disclosure. The transceiver 1000 includes a transmitting multicore fiber (MCF) 101, a receiving multicore fiber (MCF) 102, a MCF fiber attachment unit (FAU) 110, a first MCF converter 121, a second MCF converter 122, and a transmitter and receiver array 150. The transmitter and receiver array 150 includes a laser source 151, a modulator array 152, drivers 153, a first optional Serializer/Deserializer (SERDES)/retimer 154, a photodetector (PD) array 155, a Transimpedance Amplifier (TIA) 156, and a second optional SERDES/retimer 157. The MCF fiber attachment unit (FAU) 110 provides a mechanical and optical interface for attaching the multicore fibers 101, 102 to the MCF converters 121, 122, respectively. The first multicore fiber (MCF) converter 121 is configured to interface with the transmitting MCF 101, and the second MCF converter 122 is configured to interface with the receiving MCF 102. The transmitter and receiver array 150 is coupled to the MCF converters 121, 122 and is configured to process signals received from or transmitted to the MCFs 101, 102 via the MCF converters 121, 122.

In some embodiments, the MCF transceiver may be configured for bidirectional operation using separate transmitting and receiving multicore fibers. In other embodiments, the MCF transceiver may be configured for unidirectional operation using a single multicore fiber for either transmission or reception.

The laser source 151, modulator array 152, drivers 153, and SERDES/retimer 154 together constitute a transmitter array, while the photodetector (PD) array 155, TIA 156, and SERDES/retimer 157 together constitute a receiver array.

In operation, the components of the multi-core fiber transceiver 1000 interact to perform optical signal transmission and reception. On the transmit side, electrical signals are received by the optional SERDES/retimer 154, processed by the drivers 153, and used to modulate optical signals from the laser source 151 via the modulator array 152. The modulated optical signals are then directed through the MCF converter 121 to the MCF 101. On the receive side, optical signals from the MCF 102 are received by the MCF converter 122, converted to electrical signals by the PD array 155, amplified by the TIA 156, and processed by the optional SERDES/retimer 157. The arrangement of components enables efficient high-density optical communication in a compact form factor.

The SERDES/retimer 154 and the SERDES/retimer 157 are optional components of the transmitter and receiver array 150. In some embodiments, the transmitter and receiver array 150 may not include the SERDES/retimer 154, the SERDES/retimer 157, or both. In such embodiments, electrical signals may be provided directly to the drivers 153 on the transmit side, and electrical signals from the TIA 156 may be output directly on the receive side without retiming or serialization/deserialization processing. In some embodiments, the transmitter and receiver array 150 may include only the SERDES/retimer 154 on the transmit side without the SERDES/retimer 157 on the receive side, or vice versa, depending on the signal processing requirements of the application.

The transceiver 1000 in the embodiment illustrated in FIG. 1 includes two MCFs, with the transmitting MCF 101 and the receiving MCF 102 each having four cores carrying four signals. However, the present disclosure is not limited thereto. For example, a transceiver may have four MCFs, with two MCFs on the transmitter side each carrying four signals, and two MCFs on the receiver side each carrying four signals. For another example, a transceiver may have eight MCFs, with four MCFs on the transmitter side each carrying four signals, and four MCFs on the receiver side each carrying four signals. The number of MCFs and the number of cores per fiber may be varied according to the bandwidth requirements and design constraints of a particular application.

In some embodiments, each MCF may include 2, 4, 7, 8, 12, or 19 cores. The number of cores per fiber may be selected based on the desired bandwidth density and manufacturing considerations. In some embodiments, the laser source 151 may include one or more laser sources, and the number of laser sources may be selected based on the requirements of the actual application.

In some embodiments, the laser source 151 may be a distributed feedback (DFB) laser, a vertical-cavity surface-emitting laser (VCSEL), or an external cavity laser. The laser source 151 may be integrated on the PIC or externally coupled to the PIC.

The MCF converter 121, 122 in FIG. 1 may be implemented using various fan-in/fan-out (FIFO) technologies. In some aspects, the MCF converter may be a free space coupling type, in which light from single-mode fibers is deformed into parallel light using collimating lenses at the edge of the MCF, so that each light couples to one core of the MCF. The free space coupling type may provide low insertion loss and low crosstalk by precisely adjusting the lenses. However, the free space coupling type may have a relatively large size due to being composed of many optical parts (e.g., lenses, collimators) and may require robustness to vibration. In some aspects, the MCF converter may be a fused tapered type, in which each single-mode fiber is inserted into a multi-porous glass capillary, and then the glass itself is annealed, drawn, and cut to form a FIFO device with a cross-sectional structure similar to an MCF. The fused tapered type may provide capability of fusion splice by using conventional MCF fusion splice equipment. However, the fused tapered type may require mode field diameter (MFD) differences between the single-mode fiber and the MCF to be small to enable low splice loss. In some aspects, the MCF converter may be a 3D waveguide (3DWG) type, in which a waveguide is formed in a high and low refractive index area. The 3DWG type may provide a compact form factor. However, the 3DWG type may have relatively large insertion loss.

In some embodiments, some or all of the components of the transmitter and receiver array 150 are formed in a photonic integrated circuit (PIC). As used herein, a PIC refers to a device that integrates multiple photonic functions on a single substrate, enabling the manipulation and processing of optical signals in a compact form factor.

In some embodiments, the PIC may be implemented using various material platforms and device technologies. The PIC may be a silicon photonics (SiPhotonics) PIC, which leverages mature CMOS fabrication processes to enable high-volume, low-cost manufacturing of photonic components. Silicon photonics PICs may integrate waveguides, modulators, and other passive optical components on a silicon-on-insulator (SOI) substrate. Alternatively, the PIC may be a thin-film lithium niobate (TFLN)-on-silicon PIC, which combines the high electro-optic coefficient of lithium niobate with the integration capabilities of silicon photonics. TFLN-on-silicon PICs may provide advantages in terms of modulation efficiency and bandwidth compared to pure silicon photonics implementations. The PIC may include indium gallium arsenide (InGaAs) photodetectors (PDs), which may provide high responsivity and low dark current for detecting optical signals in the C-band and L-band wavelength ranges. Alternatively, the PIC may include germanium-on-silicon (Ge/Si) photodetectors (PDs), which may be monolithically integrated with silicon photonics components on the same substrate, thereby simplifying fabrication and reducing assembly complexity. In some implementations, the PIC may include silicon photonics modulators and germanium-on-silicon (Ge/Si) photodetectors (PDs) integrated on the same PIC, enabling a fully integrated transmitter and receiver solution with reduced footprint and improved performance. The selection of PIC material platform and device technologies may depend on factors such as the required bandwidth, power consumption, operating wavelength, and manufacturing cost for a particular application.

In one example, the modulator array 152, drivers 153, and SERDES/retimer 154 are formed in the PIC, while the photodetector (PD) array 155, TIA 156, and SERDES/retimer 157 are formed as separate components. In another example, the modulator array 152 and the photodetector (PD) array 155 are formed in the PIC, while the drivers 153, SERDES/retimer 154, TIA 156, and SERDES/retimer 157 are formed as separate electronic components. In yet another example, the laser source 151, modulator array 152, and photodetector (PD) array 155 are integrated in the PIC, with the remaining components implemented as discrete electronic circuits. In a further example, all components of the transmitter and receiver array 150 except for the laser source 151 are formed in the PIC, with the laser source 151 being externally coupled to the PIC.

In some embodiments, the modulator array 152 may include Mach-Zehnder modulators (MZMs), electro-absorption modulators (EAMs), or ring modulators. The modulator array 152 may support various modulation formats including non-return-to-zero (NRZ), pulse amplitude modulation (PAM4), or higher-order PAM formats.

In some embodiments, the transmitter array and the receiver array in the transmitter and receiver array 150 may be implemented using different configurations. The transmitter array may be a parallel single-mode (PSM) transmitter array formed in the PIC, with components of the receiver array being separate from the PIC. A PSM transmitter array includes a plurality of single-mode optical transmitters arranged in parallel, where each transmitter is configured to operate independently for emitting light at the same wavelength through separate optical channels. This configuration allows for straightforward scaling of bandwidth by adding additional parallel channels. Alternatively, the transmitter array may be a wavelength division multiplexing (WDM) transmitter array formed in the PIC, with components of the receiver array being separate from the PIC. A WDM transmitter array includes a plurality of laser diodes, each tuned to emit a light signal at a specific wavelength and encoded with specific data, and a multiplexer configured to combine the light signals emitted by the laser diodes into a single output signal. The WDM approach enables multiple data streams to be transmitted simultaneously over a single optical core by utilizing different wavelengths, thereby increasing the overall data capacity without requiring additional physical channels. The selection between PSM and WDM configurations may depend on factors such as the required bandwidth, power budget, and system complexity for a particular application.

In some embodiments, the MCF transceiver may operate in the O-band (1260-1360 nm), C-band (1530-1565 nm), or L-band (1565-1625 nm) wavelength ranges. The selection of wavelength range may depend on the fiber characteristics and application requirements.

In some embodiments, the transmitter array and the receiver array may be formed in the same PIC, which may provide advantages in terms of reduced footprint, simplified assembly, and improved signal integrity by minimizing the electrical interconnect lengths between the transmitter and receiver components.

In some embodiments, the MCF transceiver may support data rates of 100 Gbps, 200 Gbps, 400 Gbps, 800 Gbps, 1.6 Tbps, or higher per transceiver. The data rate may be achieved through a combination of the number of optical channels, modulation format, and baud rate.

In some embodiments, the PIC may be formed with a waveguide, and a pitch of the waveguide of the PIC may be aligned to a pitch of the MCF. Aligning the waveguide pitch to the MCF pitch may facilitate efficient optical coupling between the PIC and the MCF, reducing insertion loss and improving signal quality.

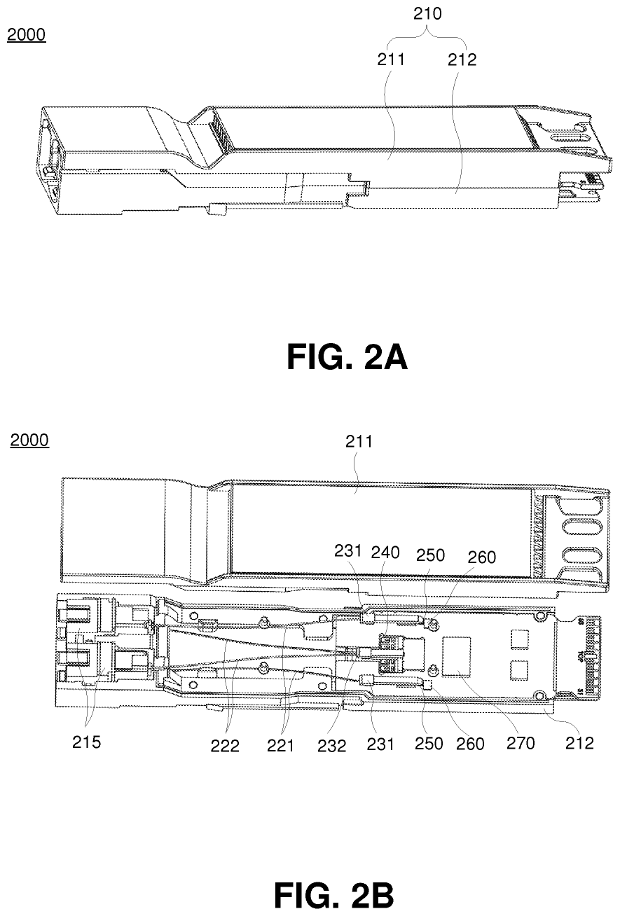

FIG. 2A is a perspective view of a multicore fiber optical transceiver 2000 according to an embodiment of the present disclosure. FIG. 2B is an exploded perspective view of the multicore fiber optical transceiver 2000 of FIG. 2A. As illustrated in FIGS. 2A and 2B, the transceiver 2000 includes a housing 210 having an upper housing 211 and a lower housing 212, two adapters 215, two receiving multicore fibers (RX MCFs) 221, two transmitting multicore fibers (TX MCFs) 222, two receiving 3D waveguides (RX-3DWGs) 231, a transmitting 3D waveguide (TX-3DWG) 232, four laser emitters 240, two photodetectors (PDs) 250, a trans impedance amplifier (TIA) 260, and a photonic integrated circuit (PIC) 270. The two adapters 215 are located at one end of the housing 210, each interfacing with one RX MCF 221 and one TX MCF 222. The laser emitters 240 are located within the housing 210, providing a light source for signal transmission. The PDs 250 are positioned to receive incoming optical signals and the TIAs 260 process these signals. The two RX-3DWGs 231 are positioned to guide optical signals from the two RX MCFs 221 to the two PDs 250, and the two TX-3DWG 232 are positioned to guide optical signals from the four laser emitters 240 to the RX MCFs 222. The PIC 270 at the core of the transceiver 2000 integrates various optical and electronic components for signal processing. For example, PIC 270 may include one or more modulators (e.g., the modulator array 152 in FIG. 1), drivers (e.g., the drivers 153 in FIG. 1), SERDES and retimers (e.g., the SERDES/retimer 154 or 157 in FIG. 1). The arrangement of these components within the housing 210 may allow for efficient transmission and reception of optical signals through the multi-core fibers, enabling high-density optical communication in a compact form factor.

The integration of the PIC 270 in the transceiver 2000 provides several benefits, including reduced power consumption, improved signal integrity due to shorter electrical interconnects, and enhanced thermal management by consolidating heat-generating components. Additionally, the PIC 270 enables high levels of integration and miniaturization, which contributes to the overall compact form factor of the transceiver 2000 while supporting increased bandwidth density.

The housing 210 may be a single-piece housing or a multi-piece housing. The housing 210 may be made of metal, plastic, or a combination thereof, and may include heat dissipation features such as fins or thermal interface materials.

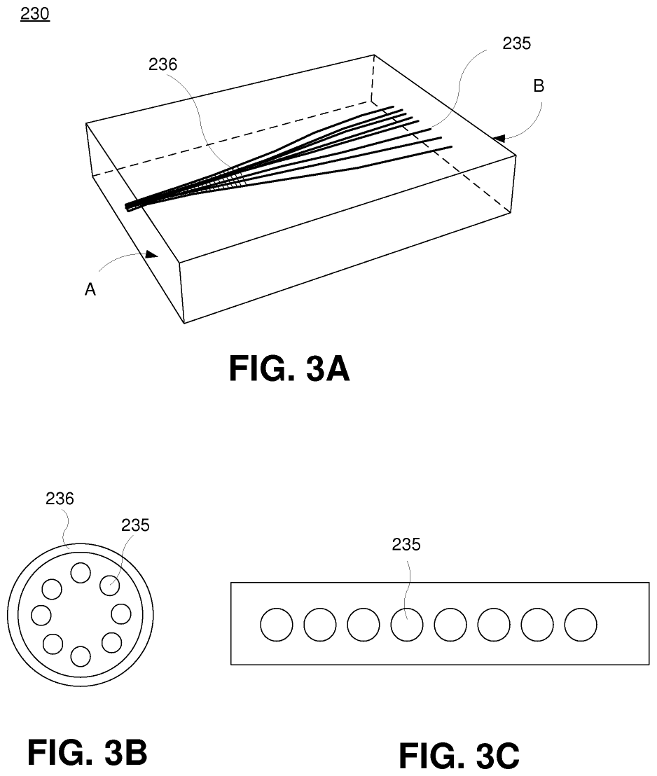

FIG. 3A is a perspective view of a 3D waveguide (3DWG) 230 according to an embodiment of the present disclosure. FIG. 3B is a side view of the 3DWG 230 of FIG. 3A from a first end, according to an embodiment of the present disclosure. FIG. 3C is a side view of the 3DWG 230 of FIG. 3A from a second end, according to an embodiment of the present disclosure. The 3DWG 230 illustrated in FIGS. 3A, 3B, and 3C may be an implementation of the RX-3DWG 231 or the TX-3DWG 232 shown in FIG. 2B. The first end A of the 3DWG 230 is configured to couple with a MCF (e.g., the RX MCF 221 or the TX MCF 222), while the second end B of the 3DWG 230 is configured to couple with a component of a transmitter and receiver array (e.g., the laser emitters 240 or the PDs 250).

As illustrated in FIG. 3A. the 3DWG 230 extends from the first end A to the second end B. Within the 3DWG 230, multiple optical cores 235 are embedded, allowing for the transmission of optical signals. Surrounding the optical cores 235 is a protective mesh 236, which extends around the perimeter of the 3DWG 230 and may serve to provide structural support and protection for the optical cores 235.

As illustrated in FIG. 3B, at the first end A, the optical cores 235 are arranged in a circular pattern. The side view from the first end A provides insight into the internal structure and arrangement of the optical cores 235 within the waveguide. The circular arrangement of the optical cores 235 may allow for parallel transmission of multiple optical signals, potentially increasing the data capacity of the waveguide.

As illustrated in FIG. 3C, at the second end B, the optical cores 235 are arranged in a linear pattern. The transition from the circular arrangement at the first end A to the linear arrangement at the second end B may facilitate coupling between the MCF and other optical components such as the PIC. The 3DWG 230 design may enable efficient transmission of multiple optical signals through a compact form factor, which may be beneficial in high-density optical communication applications.

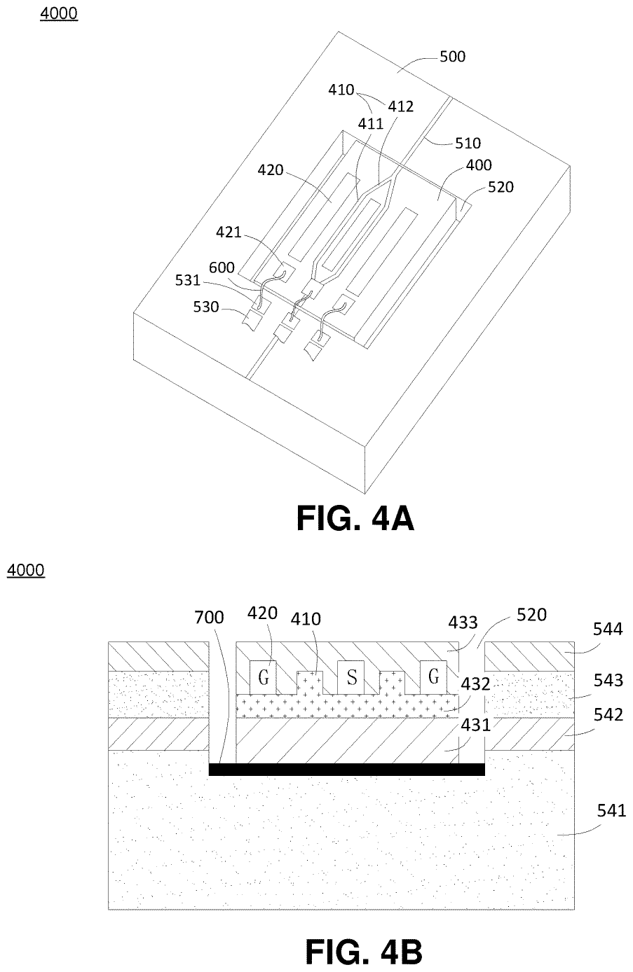

As described above, the PIC may be implemented using various material platforms including silicon photonics, thin-film lithium niobate on silicon, or hybrid integration approaches. The following description with reference to FIGS. 4A and 4B provides an example of a photonic integrated chip that combines an optoelectronic chip with a silicon photonic chip to achieve high-performance optical modulation.

FIG. 4A is a perspective view of a photonic integrated chip 4000 according to an embodiment of the present disclosure. FIG. 4B is a cross-sectional view of the photonic integrated chip 4000 of FIG. 4A. As illustrated in FIGS. 4A and 4B, the photonic integrated chip 4000 includes an optoelectronic chip 400 and a silicon photonic chip 500. The material of the optoelectronic chip 400 is different from the material of the silicon photonic chip 500. Here, the primary materials of the aforementioned two chips 400 and 500 are different, and the two chips 400 and 500 may include some materials in common. For example, the optoelectronic chip 400 is primarily made of lithium niobate, and the silicon photonic chip 500 is primarily made of silicon. Here, the optoelectronic chip 400 is a lithium niobate thin film modulator. In other embodiments, the optoelectronic chip 400 may alternatively be a modulator made of another material or an optoelectronic chip of another function. For example, the optoelectronic chip 400 may be made of a III-V material, or the optoelectronic chip 400 may be a photoelectric detector or a laser.

In the embodiment illustrated in FIGS. 4A and 4B, the optoelectronic chip 400 (the lithium niobate thin film modulator) includes, stacked sequentially, a silicon dioxide base layer 431, a lithium niobate waveguide layer 432, a silicon dioxide cover layer 433, and a first electrode 420 disposed in the silicon dioxide cover layer 433. In the embodiment, GSG (ground-signal-ground) electrodes may be used as an example for the first electrode 420. That is, the first electrode 420 includes a signal electrode(S) and two ground electrodes (G). A first waveguide 410 is disposed in the lithium niobate waveguide layer 432. In the embodiment, the first waveguide 410 includes two modulation zone waveguides 411 in the middle and two Y-shaped waveguides 412 at two opposite ends of modulation zone waveguides 411. The silicon photonic chip 500 includes, stacked sequentially, a silicon substrate layer 541, a buried layer 542, a silicon top layer 543, and a cover layer 544. A second waveguide 510 is disposed in the silicon top layer 543. A second electrode 530 is disposed in the cover layer 544. The second electrode 530 includes three electrodes corresponding to the GSG electrodes on the optoelectronic chip 400, respectively. An installation recess 520 is formed on the silicon photonic chip 500 and divides the second waveguide 510 into an input segment and an output segment. Only a portion of the silicon photonic chip 500 is shown in FIGS. 4A and 4B. Other waveguides and electrodes as well as active and passive devices, such as a photodetector or a wavelength division multiplexer, may be integrated onto the complete silicon photonic chip 500.

The optoelectronic chip 400 is installed in the installation recess 520. An optical signal passes through the input segment of the second waveguide 510 before entering into the first waveguide 410. The optical signal is modulated by an electrical signal on the first electrode 420 as the optical signal passes through the modulation zone waveguide 411 of the first waveguide 410, and then the optical signal is output through the first waveguide 410 before entering into the output segment of the second waveguide 510. In the embodiment illustrated in FIGS. 4A and 4B, a glue layer 700 may be applied between a bottom portion of the optoelectronic chip 400 and a bottom of the installation recess 520 to adhere the optoelectronic chip 400 into the installation recess 520, the optoelectronic chip 400 being partially or entirely embedded in the installation recess 520. In other embodiments, additionally or alternatively, glue may be placed between the optoelectronic chip 400 and a wall of the installation recess 520 to adhere the optoelectronic chip 400. Glue of the glue layer may be a heat curable glue or a UV curable glue. Three solder pads 421 electrically connected to the GSG electrodes on the optoelectronic chip 400, respectively, are disposed on an upper surface of the optoelectronic chip 400. Once the optoelectronic chip 400 is secured and installed, gold wires 600 are used to electrically connect the solder pads 421 of the first electrode 420 on the optoelectronic chip 400 to corresponding solder pads 531 of the second electrode 530 on the silicon photonic chip 500, and the second electrode 530 on the silicon photonic chip 500 is electrically connected to an external circuit or power source. In other embodiments, alternatively, electrical connection between the solder pads 531 and the second electrode 530 may be realized by means of solder joints. Or, the solder pads 421 of the first electrode 420 are disposed at a bottom surface of the optoelectronic chip 400, the solder pads 531 of the second electrode 530 are disposed at the bottom of the installation recess 520, and the first electrode 420 and the second electrode 530 are electrically connected by means similar to flip-chip soldering. Alternatively, the solder pads 421 of the first electrode 420 may be disposed on a side surface of the optoelectronic chip 400, the solder pads 531 of the second electrode 530 may be disposed on a wall in the installation recess 520 facing the solder pads 421 of the first electrode 420, and the first electrode 420 and second electrode 530 are electrically connected by means of soldering or an electrically conductive glue.

In the embodiment illustrated in FIGS. 4A and 4B, integration between the silicon photonic chip 500 and the optoelectronic chip 400 (the lithium niobate thin film modulator) is realized by a non-bonding method. The cover layer 544 on a surface of the silicon photonic chip 500 does not need to be made thin. Electrodes may still be made on the silicon photonic chip 500, and active devices such as a photodetector may further be manufactured on the silicon photonic chip 500, thus resolving the problem of insufficient bandwidth of a silicon-based modulator while preserving advantages of the silicon photonic chip 500 in integrating passive and active devices, thereby improving the level of integration of the silicon photonic chip 500.

In the embodiment illustrated in FIGS. 4A and 4B, optical connection (not shown in the drawings) between the input segment of the second waveguide 510 on the silicon photonic chip 500 and the Y-shaped waveguide 412 at one end of the first waveguide 410 of the optoelectronic chip 400 is realized by means of photonic wire bonding (PWB), and optical connection between the Y-shaped waveguide 412 at the other end of the first waveguide 410 and the output segment of the second waveguide 510 is realized by means of photonic wire bonding. By realizing optical connection by means of photonic wire bonding, the positions of the first waveguide 410 and the second waveguide 510 can be flexible. Therefore, in the first embodiment, the first waveguide 410 may or may not be aligned with the second waveguide 510, the position of the optoelectronic chip 400 in the installation recess 520 can be flexible, and thus requirement on the precision of the installation recess 520 is relatively low, making the manufacturing easy and significantly reducing the difficulty of the installation of the optoelectronic chip, thereby enabling an effective improvement in production efficiency.

In some aspects, the multi-core fiber transceiver may be implemented as a co-packaged optics (CPO) device. The CPO device includes a MCF converter configured to interface with a plurality of optical cores of a MCF, and a transmitter and receiver array coupled to the MCF converter and configured to process optical signals received from or transmitted to the MCF converter. At least part of the transmitter and receiver array may be formed in a PIC. The CPO implementation may provide advantages in terms of reduced power consumption and improved signal integrity by placing the optical components closer to the electronic processing elements.

The multi-core fiber transceiver may be configured in various form factors including Quad Small Form-factor Pluggable (QSFP), Quad Small Form-factor Pluggable Double Density (QSFP-DD), Octal Small Form-factor Pluggable (OSFP), Octal Small Form-factor Pluggable Extended Distance (OSFP-XD). The selection of form factor may depend on the specific application requirements, including the number of channels needed, power budget, and physical space constraints.

In some embodiments, the MCF transceiver may include thermal management components such as a thermoelectric cooler (TEC), heat sink, or thermal interface material to maintain optimal operating temperature for the optical and electronic components.

In some embodiments, the optical interconnect may employ near-packaged optics (NPO), external-packaged optics (XPO), and/or co-packaged optics (CPO) architectures. In an NPO architecture, one or more optical engines are disposed on a substrate or circuit board in close proximity to a host integrated circuit, such as a switch or processor, such that lengths of the electrical interconnections between the host integrated circuit and the optical engines are shortened relative to conventional front-panel pluggable transceivers. In an XPO architecture, the optical engines are implemented as discrete optical modules or assemblies external to the package of the host integrated circuit and are configured to electrically interface with the host integrated circuit over short-reach electrical connections and to optically interface with external optical fibers. In a CPO architecture, one or more optical engines are co-packaged with the host integrated circuit within a common package or package substrate, thereby further reducing electrical interconnect length between the host integrated circuit and the optical engines. The use of NPO, XPO, and/or CPO architectures may reduce electrical signal loss, power consumption, and latency while enabling high-bandwidth optical communication.

In some embodiments, the MCF transceiver may include an electrical interface configured to connect to a host device. The electrical interface may support various protocols including PCIe, Ethernet, or proprietary high-speed serial interfaces.

The multicore fiber optical transceiver described herein addresses the challenges associated with managing large numbers of optical fibers in high-density data center environments. By integrating MCF with PICs, the transceiver may significantly reduce the number of optical input/output fibers required while maintaining high data throughput. For example, a MCF with four cores may achieve a signal channel-to-fiber count ratio of 4:1, thereby reducing the total fiber count by a factor of four compared to conventional single-core fiber solutions. The integration of transmitter and receiver components in a PIC may provide additional advantages including reduced power consumption, improved signal integrity due to shorter electrical interconnects, and a compact form factor suitable for high-density deployments. Furthermore, the use of PSM configurations may avoid the optical loss, cost, and wavelength control challenges associated with traditional WDM optics, while still achieving high bandwidth density. The various embodiments described herein, including different MCF converter types, PIC technologies, and form factors, provide flexibility to address a wide range of application requirements in AI data centers and other high-performance computing environments

A number of implementations have been described. Nevertheless, it will be understood that various modifications may be made without departing from the spirit and scope of the disclosure. Accordingly, other implementations are within the scope of the following claims.

1. A multicore fiber (MCF) optical transceiver, comprising:
at least one multicore fiber (MCF) including a plurality of optical cores;
at least one multicore fiber (MCF) converter configured to interface with the plurality of optical cores of the MCF; and
a transmitter and receiver array coupled to the MCF converter and configured to process signals received from or transmitted to the MCF via the MCF converter,
wherein at least part of the transmitter and receiver array is formed in a photonic integrated circuit (PIC).

2. The MCF optical transceiver of claim 1, wherein the MCF includes a transmitting MCF and a receiving MCF, and
the transmitter and receiver array comprises:
a laser source configured to provide optical signals to the transmitting MCF;
a modulator array configured to modulate the optical signals;
drivers configured to provide driving signals to the modulator array;
a photodetector array configured to convert optical signals received from the receiving MCF to electrical signals; and
a transimpedance amplifier configured to amplify the electrical signals from the photodetector array.

3. The MCF optical transceiver of claim 1, further comprising a MCF fiber attachment unit configured to provide a mechanical and optical interface for attaching the at least one multicore fiber to the at least one MCF converter.

4. The MCF optical transceiver of claim 1, wherein the transmitter and receiver array comprises:
a transmitter array; and
a receiver array.

5. The MCF optical transceiver of claim 4, wherein
the transmitter array is a parallel single-mode (PSM) transmitter array formed in the PIC; and
the receiver array are separate from the PIC.

6. The MCF optical transceiver of claim 4, wherein
the transmitter array is a wavelength division multiplexing (WDM) transmitter array formed in the PIC; and
the receiver array are separate from the PIC.

7. The MCF optical transceiver of claim 4, wherein the transmitter array and the receiver array are formed in the same PIC.

8. The MCF optical transceiver of claim 1, wherein the PIC is formed with a waveguide, a pitch of the waveguide of the PIC is aligned to a pitch of the MCF.

9. The MCF optical transceiver of claim 1, wherein the MCF converter is a free space coupling type in which light from single-mode fibers is deformed into parallel light using collimating lenses at an edge of the MCF.

10. The MCF optical transceiver of claim 1, wherein the MCF converter is a fused tapered type in which each single-mode fiber is inserted into a multi-porous glass capillary, and the glass is annealed, drawn, and cut to form a fan-in/fan-out device with a cross-sectional structure similar to the MCF.

11. The MCF optical transceiver of claim 1, wherein the MCF converter is a 3D waveguide type in which a waveguide is formed in a high and low refractive index area.

12. The MCF optical transceiver of claim 11, wherein the 3D waveguide includes:
a plurality of optical cores embedded within the 3D waveguide; and
a protective mesh surrounding the plurality of optical cores;
wherein the plurality of optical cores are arranged in a circular pattern at a first end of the 3D waveguide and in a linear pattern at a second end of the 3D waveguide.

13. The MCF optical transceiver of claim 1, wherein the MCF transceiver is configured in a form factor selected from a group comprising Quad Small Form-factor Pluggable (QSFP), Quad Small Form-factor Pluggable Double Density (QSFP-DD), Octal Small Form-factor Pluggable (OSFP), Octal Small Form-factor Pluggable Extended Distance (OSFP-XD), near-packaged optics (NPO), external-packaged optics (XPO), and co-packaged optics (CPO).

14. The MCF optical transceiver of claim 1, wherein the PIC is a silicon photonics (SiPhotonics) PIC.

15. The MCF optical transceiver of claim 1, wherein the PIC is a thin-film lithium niobate (TFLN)-on-silicon PIC.

16. The MCF optical transceiver of claim 1, wherein the PIC comprises indium gallium arsenide (InGaAs) photodetectors (PDs).

17. The MCF optical transceiver of claim 1, wherein the PIC comprises germanium-on-silicon (Ge/Si) photodetectors (PDs).

18. The MCF optical transceiver of claim 1, wherein the PIC comprises silicon photonics modulators and germanium-on-silicon (Ge/Si) photodetectors (PDs).
